(19) United States
(12) Patent Application Publication
(10) Pub. No.: US 2023/0178940 A1
(43) Pub. Date: Jun. 8, 2023

(54) ELECTRICAL CONNECTING DEVICE, TRANSCEIVER SYSTEM AND METHOD FOR OPERATING THE ELECTRICAL CONNECTING DEVICE

(71) Applicants: ETO MAGNETIC GMBH, Stockach (DE); NETWAKE GMBH, Überlingen (DE)

(72) Inventors: Sharang Deepak Parnerkar, Stockach (DE); Marcel Ruff, Ueberlingen (DE)

(21) Appl. No.: 17/921,953

(22) PCT Filed: Apr. 30, 2021
(86) PCT No.: PCT/EP2021/061457

§ 371 Date: Oct. 27, 2022

(30) Foreign Application Priority Data
Apr. 30, 2020 (DE) 10 2020 111 868.6

(51) Int. Cl. H01R 13/66; H02J 50/00

(52) U.S. Cl. CPC H01R 13/6675; H02J 50/001

(57) ABSTRACT

An electrical connection device, in particular an electrical plug connector device, having at least one connection element which is configured for a physical connection to a data line, the electrical connection device further comprising a signal harvesting unit, in particular an RS-232 signal harvesting unit, which is configured to divert at least a portion of an electrical data signal emitted by the data line in order to obtain electrical energy, in particular at least to obtain electrical operating energy for signal-based data conversion and/or for radio-based signal transmission.

### PRIOR ART

The invention relates to an electrical connection device according to the preamble of claim 1, a transceiver system according to claim 19, and a method for operating the electrical connection device according to the preamble of claim 22.

Electrical connection devices having at least one connection element configured for a physical connection to a data line, for example various forms of commercially available D-subminiature connectors, are already known.

The object of the invention is, in particular, to provide a device of the type in question with advantageous properties with regard to the simplest possible operability and/or with regard to flexibility of use. According to the invention, the object is achieved by the features of claims 1, 19 and 22, while advantageous embodiments and developments of the invention can be taken from the dependent claims.

### ADVANTAGES OF THE INVENTION

The invention is based on an electrical connection device, in particular an electrical plug connector device, having at least one connection element which is configured for a physical connection to a data line.

It is proposed that the electrical connection device has a signal harvesting unit, in particular an RS-232 signal harvesting unit, which is configured to divert at least a portion of an electrical data signal emitted by the data line in order to obtain electrical energy, in particular at least to obtain electrical operating energy for a signal-based data conversion and/or for a radio-based signal transmission. In this way, a particularly simple operability and/or a high flexibility of use can be advantageously achieved, in particular by dispensing with an additional power supply of the electrical connection device required, for example, for the signal-based data conversion. In particular, many places of use are conceivable where a permanent power supply via power supply units or via USB connections cannot be provided or cannot be provided without a high level of additional effort, such as within means of transport such as land, air and/or water vehicles. For example, many control devices are not equipped with a power output and are not equipped with a data output which is also partially configured for a power output, such as a Universal Serial Bus (USB) data output. For example, many plugs installed and/or built into walls, floors or cable ducts of means of transport, in particular installed some time ago, are not provided with power-transmitting connections, such as a USB connection. For example, an advantage of an RS-232 connection is that cable lengths in excess of 100 m at 9600 baud are not uncommon, wherein other technologies, such as USB cables, are limited to lengths of approximately 5 m. In addition, it is advantageous that there is also no need for a power supply using energy storage devices such as batteries or accumulators, which means that maintenance costs advantageously can be kept low. Advantageously, a high energy efficiency can be achieved. In addition, special programming of the system transmitting the data signal, in particular by the user, advantageously can be spared. Advantageously, a plug-and-play-compatible connecting device with signal-based data conversion capacity can thus be obtained.

An “electrical connection device”, in particular an “electrical plug connector device”, shall preferably be understood to mean at least a part, in particular a sub-assembly, of an electrical plug connector which is configured for a disconnection and/or connection of electrical lines. In particular, the electrical connection device may comprise an entire plug connector. In particular, the electrical connection device is formed as a serial interface plug. In particular, the electrical plug connector has a D-subminiature design, preferably a DE-09 design, a DB-25 design or another standardized D-subminiature design used in particular for RS-232 interfaces. Alternatively, but less preferably, it is furthermore also conceivable that the electrical plug connector has a mini-DIN design, a modular-8P8C design or a completely company-specific design. In particular, the electrical connection device comprises one or more connection elements. For example, at least one of the connection elements may be formed as a male connection part, in particular a plug with contact pins pointing outward, of an electrical plug connector. For example, at least one of the connection elements may be formed as a female connecting part, in particular a socket with inwardly pointing contact openings, of an electrical plug connection. In particular, the electrical connection device forms a type of dongle, preferably a dongle. In particular, the electrical connection device, preferably the dongle, has a radio transmission capacity. In particular, the dongle is configured to communicate with at least one further dongle, in particular an at least substantially identically formed dongle, by radio transmission. The expression “physical connection to the data line” shall be understood to mean in particular a connection which is configured to establish an electrical contact with the data line, and/or which is configured to tap off and/or transmit an electrical signal. The term “configured” shall be understood in particular to mean specially programmed, designed and/or equipped. The fact that an object is configured for a certain function shall be understood in particular to mean that the object fulfills and/or executes this certain function in at least one application and/or operating state.

A “signal harvesting unit” shall be understood in particular to be an electrical unit which is configured to extract and/or recover electrical energy from an electrical data signal, for example a serial data signal of an RS-232 interface. Preferably, the signal harvesting unit is configured to supply the extracted and/or recovered electrical energy to a new purpose (for example, a radio-based signal transmission, a signal-based data conversion, and/or an energy storage device charging) that is different from the original purpose (for example a wired signal transmission). In particular, the signal harvesting unit is configured to extract electrical energy from the transmitted data signal and/or to obtain electrical energy from the transmitted data signal during an active data transmission through the data line. In addition, the signal harvesting unit is preferably configured to extract electrical energy from an idle state signal of the data line and/or to obtain electrical energy from the idle state signal of the data line during an idle state of the data line. In particular, the signal harvesting unit is configured to extract electrical energy from the transmitted simplex data signal and/or to obtain electrical energy from the transmitted simplex data signal during an active simplex data transmission operation of the data line. In particular, the signal harvesting unit is configured to extract electrical energy from the transmitted duplex data signal and/or to obtain electrical energy from the transmitted duplex data signal during an active duplex data transmission operation of the data line. In particular, the data line is formed as an electrical data line. An “electrical data signal emitted by the data line” shall be understood in particular to mean a current signal or preferably a voltage signal which is preferably generated and/or emitted by a device, for example a computer, connected to an opposite end of the data line. A “signal-based data conversion” shall be understood in particular to mean a conversion of an input data signal, for example the (serial RS-232) data signal of the data line into an output data signal, for example a (Bluetooth Low Energy) radio data signal.

If the electrical data signal used in particular by the signal harvesting unit for obtaining energy is an electrical voltage signal, an effective, in particular energy-efficient, signal harvesting can be advantageously enabled. In particular, the electrical data signal is a voltage interface data signal. Alternatively, but less preferably, the electrical data signal could also be a data signal of a current interface. Preferably, the electrical data signal is a modulated voltage signal. In particular, the electrical data signal is a data signal, in particular a digital data signal, in which preferably binary states are realized by changing the electrical voltage levels, for example by different, preferably positive and negative, electrical voltage levels.

If, in addition, the electrical data signal used in particular by the signal harvesting unit for obtaining power is a Recommended Standard 232 (RS-232) signal or a Universal Asynchronous Receiver Transmitter (UART) signal of a serial interface, in particular an RS-232 interface or a Universal Asynchronous Receiver Transmitter (UART) interface, an adapter for a widespread data transmission standard, which is usually free of an integrated power supply, can advantageously be obtained without the need for an additional power supply, an additional energy storage device or a special programming, in particular on the part of the user, of a system transmitting the data signal. Advantageously, a power supply of the electrical connection device can thereby already be realized by the typical (standardized) UART settings and/or by the typical (standardized) RS-232 settings. Alternatively or additionally, it is conceivable that the electrical data signal is a data signal of a serial Dual Universal Asynchronous Receiver Transmitter (DUART) interface or a data signal of a serial Universal Synchronous/Asynchronous Receiver Transmitter (USART) interface. In particular, a UART signal converts between 0 V and a maximum of about +5 V, preferably between 0 V and about +3 V. In particular, the RS-232 signal converts between −12 V and +12 V. In particular, a voltage level of the RS-232 signal is considered to be 0 (space) when the voltage level of the RS-232 signal is between +3 V and +15 V. In particular, a voltage level of the RS-232 signal is evaluated as 1 (mark) when the voltage level of the RS-232 signal is between −3 V and −15 V. In particular, it is conceivable that the electrical connection device, preferably the UART interface, comprises a level converter which is at least configured to adapt voltages to a typical UART voltage level and/or to a typical RS-232 voltage level, preferably to convert voltages between the typical UART voltage level and the typical RS-232 voltage level.

It is further proposed that the electrical data signal, in particular used by the signal harvesting unit to obtain energy, is at least a Tx signal of the serial interface, in particular a signal of a Transmitted exchange Data (TxD) data line of the UART interface and/or the RS-232 interface. Advantageously, a power supply of the electrical connection device can thereby already be realized by the typical (standardized) UART settings and/or by the typical (standardized) RS-232 settings. In particular, the signal harvesting unit obtains the electrical energy from the Tx line, but alternatively it is also conceivable for energy to be obtained from an Rx line or from a GND line, in particular any line of the RS-232 connection to which a voltage is applied.

If the electrical connection device has a plug and play functional principle, advantageously a particularly simple and/or particularly user-friendly handling can be made possible. In particular, a “plug and play functional principle” shall be understood to mean that the electrical connection device is fully functional immediately after connection to a device, for example to a computer, a control unit or the like, without settings having to be made at the unit or at the electrical connection device and/or without drivers or other software programs having to be installed on the unit. In particular, firmware integrated in the electrical connection device allows direct, in particular full, operation of the electrical connection device with the typical settings of an RS-232 interface to which the electrical connection device is connected in the manner of “plug and play”. Moreover, advantageously due to the plug and play functional principle, there is no need for an external power supply of the electrical connection device, in particular a power supply different from the TxD data line of the RS-232 interface, preferably operated according to the typical RS-232 settings.

In addition, it is proposed that the signal harvesting unit is configured to divert the portion of the voltage of the electrical voltage signal that carries a negative sign at least partially, preferably completely, in order to obtain the electrical energy, in particular by means of an inversion of the electrical data signal emitted by the data line. Advantageously, a high efficiency can thus be achieved. Advantageously, a particularly effective signal harvesting can be achieved, in particular since the electrical data signal emitted by the data line predominantly has a negative voltage (cf. inter alia the RS-232 “idle” state). Moreover, the negative voltage portion in particular is not part of the UART signal, thus can advantageously be completely extracted without negatively affecting the data transmission. In particular, the electrical connection device has at least one discrete or one integrated electrical circuit, for example the level converter, a clamper, a clipper and/or an electrical valve, in particular with at least one diode, which is configured at least to divert, if necessary invert, the portion of the voltage of the electrical voltage signal that carries a negative sign, and preferably forward it to a DC-DC converter, to an energy storage device and/or to a data processing unit, for example a microcontroller.

It is additionally proposed that the signal harvesting unit is at least configured to adjust and/or limit the portion of the voltage of the electrical voltage signal that carries a positive sign to a reduced voltage level, in particular to a voltage level which is minimally necessary on the input side (at the μC or at the ASIC) in order to successfully reconstruct the data contained in the original electrical data signal, for example to a transistor-transistor logic (TTL) compatible voltage level. This can advantageously enable a, in particular direct, connection, in particular of the data line, to a pin, in particular a data input pin, of a data processing unit, in particular of a microcontroller (μC). In this way, a particularly advantageous construction of the electrical connection device, in particular of the electronic components of the electrical connection device, can be achieved. In particular, the discrete or the integrated electrical circuit of the electrical connection device, for example the level converter, the damper, the clipper and/or the electrical valve is configured to divert the portion of the voltage of the electrical voltage signal that carries a positive sign and preferably to forward it to the pin, in particular the data input pin of the μC. In addition, the discrete or the integrated electrical circuit of the electrical connection device is configured to limit and/or control a current forwarded to the pin, in particular the data input pin, to a current value that is safe for the μC. This can advantageously protect the μC, in particular a data input of the μC, against an overcurrent. A “reduced voltage level” shall be understood in particular to mean a positive voltage level below 5 V, preferably a positive voltage level below 3.3 V and particularly preferably a voltage level between about 1.2 V and about 5 V. In particular, the reduced voltage level may be the TTL-compatible voltage level or another logic voltage level (e.g., a typical complementary metal-oxide-semiconductor (CMOS) voltage level, a0 V-3 V logic level, a 0 V-5 V logic level, or the like). In particular, the data signal is extracted entirely from the portion of the voltage of the electrical voltage signal that carries a positive sign.

If, in addition, the signal harvesting unit is configured at least for the purpose of at least partially diverting the portion of the voltage of the electrical voltage signal that carries a positive sign for the purpose of obtaining electrical energy, a particularly high energy efficiency can advantageously be achieved. Advantageously, a residual energy of the portion of the voltage of the electrical voltage signal that carries a positive sign can thereby be used for charging the energy storage device or for operating the μC. In particular, the signal harvesting unit is configured to divert the surplus portion of the portion of the voltage of the electrical voltage signal that carries a positive sign remaining after the adjustment to the reduced voltage level in order to obtain electrical energy.

It is also proposed that the signal harvesting unit is at least configured for the purpose of completely diverting at least part, in particular a temporal part, of an electrical voltage signal that carries a positive sign and forms a bit, in order to obtain electrical energy. Advantageously, a particularly high energy efficiency, in particular a particularly high signal harvesting efficiency, can thus be achieved. In particular, the signal harvesting unit is configured to divert, after a successful detection of a state of a bit, a remainder of the electrical voltage signal forming the bit with the positive sign, which in particular remains at least substantially constant until an expected temporal arrival of a next bit, in order to obtain electrical energy. Furthermore, it is proposed that the electrical connection device comprises a data processing unit, in particular a microcontroller, for signal-based conversion of the electrical data signal emitted by the data line. This can advantageously enable an effective conversion, in particular a conversion that is efficient in respect of energy and/or installation space. In particular, the μC receives the electrical data signal, preferably adjusted to the reduced voltage level or the TTL-compatible voltage level. In particular, the μC converts the electrical data signal in a signal-based manner. In particular, the μC outputs the data signal converted in a signal-based manner, preferably to a radio module, preferably to a Bluetooth LE radio module (BLE≥5.0 radio module). In particular, the data processing unit may also comprise a programmable logic or hard-wired logic. In particular, the data processing unit may be an application-specific integrated circuit (ASIC) or a field-programmable gate array (FPGA).

If the data processing unit, in particular the microcontroller, is supplied with electrical energy directly or indirectly by the signal harvesting unit, a plug-and-play functionality of the electrical connection device can advantageously be achieved. Advantageously, independence from external power sources and/or batteries/accumulators can be achieved. A “direct supply with electrical energy by the signal harvesting unit” shall be understood to mean in particular an (indirect) energy supply by the electrical energy which is received, in particular without intermediate storage, at an input of the connecting device. An “indirect supply of electrical energy by the signal harvesting unit” shall be understood to mean in particular a supply of energy by electrical energy which is taken from an energy storage device which has previously been charged by energy received at the input of the connecting device.

In addition, it is proposed that the electrical connection device comprises a radio module having a transmitter which is at least configured to wirelessly emit the information contained in the electrical data signal. Advantageously, this can enable wireless signal forwarding. Advantageously, this can enable a simple and cost-effective installation. Advantageously, a flexible and/or versatile usability can thereby be achieved. In particular, the transmitter is formed as a Bluetooth transmitter, preferably as a Bluetooth 5.0 transmitter, advantageously as a Bluetooth Low Energy transmitter and preferably as a Bluetooth Low Energy ≥5.0 (BLE≥5.0) transmitter. In particular, the transmitter has a range of at least 100 m and preferably of at least 75 m. Alternatively or additionally, it is conceivable that the radio module comprises an ANT transmitter, an ANT+ transmitter, a ZigBee transmitter and/or a Z-Wave transmitter. In particular, the radio module is configured to transmit the electrical data signal converted in a signal-based manner by the μC as a wireless radio signal. Alternatively or in addition to wireless data transmission, however, it is also conceivable that the electrical connection device is configured to convert the electrical data signal, in particular the RS-232 signal, into another wired electrical data signal. In this case, the electrical connection device is formed as an adapter, which advantageously does not require an additional external power supply or an integrated battery/accumulator (examples: RS-232 to Ethernet adapter, RS-232 to CAN adapter, RS-232 to WLAN adapter, RS-232 to USB adapter, RS-232 to UART adapter etc.).

It is further proposed that the electrical connection device comprises a radio module having a receiver which is at least configured to receive radio data signals. This can advantageously enable wireless signal forwarding. Advantageously, this can enable simple and cost-effective installation. Advantageously, a flexible and/or versatile usability can thus be achieved. In particular, the receiver is formed as a Bluetooth receiver, preferably as a low-energy receiver, advantageously as a Bluetooth 5.0 receiver and preferably as a Bluetooth Low Energy ≥5.0 (BLE ≥5.0) receiver. Alternatively or additionally, it is conceivable that the radio module comprises an ANT receiver, an ANT+ receiver, a ZigBee receiver and/or a Z-Wave receiver. In particular, the electrical connection device, in particular the μC, is configured to convert in a signal-based manner the signal received by the receiver and to transmit it as an electrical data signal. In particular, it is conceivable that the transmitter and the receiver are at least partially integrally formed with each other, for example as a single antenna operable in a dual mode, in particular Bluetooth Low Energy antenna. Preferably, the radio module is configured to communicate with further radio modules of at least substantially identically formed electrical connection devices.

It is further proposed that the data processing unit, in particular the microcontroller, is configured to convert the radio data signals received by the receiver into an electrical data signal, in particular into an RS-232 data signal or, for example, a UART data signal with TTL level, which is fed into a data line, in particular a further data line to which the electrical connection device is connected, preferably in a Tx data line of the RS-232 interface, in an Rx data line of the RS-232 interface, in an Rx data line of the UART interface and/or in a corresponding data line of the UART interface. This can advantageously enable two-way communication. In particular, the electrical data signal, preferably when converted from the radio signal or after conversion from the radio signal, is ramped up to an RS-232 compliant voltage by the electrical connection device. In particular, the discrete or the integrated electronic circuit, preferably the level converter, of the electrical connection device is configured to increase the electrical data signal to a valid RS-232 level before feeding it into the (Rx) data line of the RS-232 interface. For example, the voltage level to which the increase is made by means of the level converter may be a voltage level in a range just within a valid RS-232 level of just more than ±5 V, e.g. ±5.5 V, or it may be a default RS-232 voltage level of about ±12 V. Preferably, the discrete or the integrated electronic circuit, preferably the level converter, includes a charge pump for increasing the electrical data signal.

If the radio module is supplied with electrical power directly or indirectly by the signal harvesting unit, advantageously a plug-and-play functionality of the electrical connection device can be achieved. Advantageously, independence from external power sources and/or batteries/accumulators can be achieved.

It is additionally proposed that the electrical connection device has an energy storage unit for storing at least a portion of the electrical energy obtained by the signal harvesting unit. Advantageously, this can guarantee a high level of operation readiness. Advantageously, this can enable a cold start, for example. Advantageously, this can ensure operation at a very slow baud rate, for example. In particular, the energy storage device is formed as an accumulator or as a supercapacitor. In particular, the energy storage device is configured to supply the μC with electrical energy. In particular, the energy storage device is configured to supply the radio module, in particular the transmitter and/or the receiver, with electrical energy. In particular, the energy storage device is configured to supply electrical energy to the discrete or integrated circuit. In particular, the energy storage device is configured to supply the level converter and/or the voltage pump with electrical energy.

If, in addition, the signal harvesting unit has a current and/or voltage converter, in particular a DC-DC converter, preferably an inverting buck-boost converter, which is fed by electrical energy diverted by the signal harvesting unit and which is configured to supply the energy storage device with a charging current, advantageous use of the diverted signal energy for charging the energy store can be made possible. In particular, the (positive and/or negative) voltage signal diverted by the signal harvesting unit is forwarded to the DC-DC converter. In particular, the DC-DC converter is configured to supply electrical energy to the μC. In particular, on one side, a residual energy from the DC-DC converter that is not needed by the μC is forwarded to the energy storage device and used to charge the energy storage device. In particular, on the other hand, in the, especially temporary, case that the energy from an output of the DC-DC converter is not sufficient to adequately supply the μC, electrical energy is taken from the energy storage device and supplied to the μC. This can advantageously ensure fail-safe data exchange via the electrical connection device. In particular, the DC-DC converter is configured to keep a current at the output of the DC-DC converter at least substantially stable. In particular, the DC-DC converter is configured to at least partially compensate and/or smooth the fast converting input voltage at an input of the DC-DC converter. For example, the DC-DC converter can be configured to control the current at the output of the DC-DC converter such that the energy storage device is charged with an at least substantially constant charging current. In particular, it is conceivable that the DC-DC converter is replaced by another suitable current and/or voltage converter.

Furthermore, it is proposed that the current and/or voltage converter, in particular the DC-DC converter, fed by the electrical energy diverted by the signal harvesting unit is at least configured to supply electrical energy to at least one functional component of the electrical connection device, in particular the radio module and/or the data processing unit and/or a Tx return channel of the electrical connection device, in particular the discrete or the integrated circuit, the level converter and/or the voltage pump. Advantageously, a plug-and-play functionality of the electrical connection device can thus be achieved. Advantageously, independence from external power sources and/or batteries/accumulators can be achieved.

In addition, it is proposed that the signal harvesting unit is configured to divert the entire electrical data signal emitted by the data line in order to obtain electrical energy, at least time-segment-wise, in particular at least in an idle state (RS-232 “idle” state) of the electrical data signal. Advantageously, a particularly high efficiency, in particular energy efficiency, can thus be achieved. In particular, in the RS-232 “idle” state, an RS-232 voltage level, for example a voltage level of about −12 V (higher or lower RS-232 voltage levels may occur), is permanently present at the TxD data line of the RS-232 interface, which can advantageously be used for generating a continuous charging current for charging the energy storage device.

Furthermore, a transceiver system having at least one first electrical connection device and having at least one second electrical connection device is proposed, wherein the first electrical connection device comprises at least one radio module having a transmitter, and wherein the second electrical connection device comprises at least one radio module having a receiver. As a result, a wireless transmission and/or forwarding of an RS-232 signal and/or a UART signal can advantageously be achieved, which in particular requires neither an integrated power supply nor an additional power supply unit or an additional energy storage device or a special programming, in particular on the part of the user, of a system transmitting the data signal. In particular, the first electrical connection device and the second electrical connection device are formed at least substantially identically to each other. In particular, the first electrical connection device and the second electrical connection device form a dongle pair which can communicate with each other by radio transmission. A “transceiver system” shall be understood in particular to mean a transmitter-receiver system. Alternatively or additionally, it is conceivable that at least one side of the transceiver system is formed differently from the electrical connection device. For example, one side could directly have a radio interface, for example a Bluetooth Low Energy interface, which communicates directly with the electrical connection device on the other side. Furthermore, it is conceivable that the transceiver system comprises more than one transmitter and/or more than one receiver. For example, the transceiver system could support a “one to many” radio link with at least one transmitter and two or more receivers and/or a “many to many” radio link with two or more transmitters and two or more receivers. In particular, it is conceivable that more than two electrical connection devices communicate with each other via radio signals within the transceiver system. In particular, the transceiver system is configured to advantageously replace a cable connection, especially an RS-232 cable connection.

In addition, it is proposed that a power supply of the connecting devices is independent of an external power supply that is different from a data line carrying an electrical data signal, in particular independent of an external power supply which is different from a TxD data line of an RS-232 interface or a UART interface. Advantageously, a transceiver system with a plug-and-play functionality can thus be achieved. Advantageously, independence of the transceiver system from additional external power sources and/or additional batteries/accumulators can be achieved.

It is also proposed that the radio signals communicated between the electrical connection devices are encrypted. In this way, a high level of data security can be advantageously achieved. For example, a symmetrical cryptography system, an asymmetrical cryptography system or another suitable cryptography system can be used for encryption of the radio signals. In particular, the encryption of the radio signals is optional. However, it is also conceivable that the encryption can be activated and deactivated and/or that the transceiver system is realized free of encryption of the radio signals.

In addition, a method for operating the electrical connection device having the at least one connection element which is physically connected to a data line is proposed, wherein, to obtain electrical energy, in particular at least to obtain electrical operating energy for a signal-based data conversion and/or for a radio-based signal transmission, at least a portion of an electrical data signal emitted by the data line is diverted by means of a signal harvesting unit, in particular an RS-232 signal harvesting unit. Advantageously, this makes it possible to achieve particularly simple operability and/or a high degree of flexibility of use, in particular by dispensing with an additional power supply for the electrical connection device, required, for example, for the signal-based data conversion. In particular, many places of use are conceivable where a permanent power supply via power supply units or via USB connections cannot be provided or cannot be provided without high additional effort.

In this regard, the electrical connection device according to the invention, the transceiver system according to the invention, and the method according to the invention are not intended to be limited to the application and embodiment described above. In particular, the electrical connection device according to the invention, the transceiver system according to the invention, and the method according to the invention may have a number of individual elements, components, and units different from a number of individual elements, components, and units described herein in order to fulfill a mode of operation described herein.

### DRAWINGS

Further advantages will become apparent from the following description of the drawings. A number of exemplary embodiments of the invention are shown in the drawings. The drawings, the description and the claims contain numerous features in combination. The person skilled in the art will expediently also consider the features individually and combine them to form meaningful further combinations.

In the drawings:

FIG. 1 shows a schematic illustration of a transceiver system having two electrical connection devices within a building,

FIG. 2 shows a schematic illustration of the transceiver system within a means of transport,

FIG. 3 shows a schematic perspective illustration of the electrical connection device,

FIG. 4 shows an exemplary illustration of a serial UART data signal (top) and a serial RS-232 data signal (bottom) in voltage-time graphs,

FIG. 5 shows a schematic diagram of the RS-232 data signal entering the electrical connection device, and

FIG. 6 shows a schematic flowchart of a method for operating the electrical connection device,

FIG. 7 shows a schematic illustration of the transceiver system within a means of transport formed as a commercial vehicle, and

FIG. 8 shows a schematic illustration of the transceiver system within a traffic infrastructure.

### DESCRIPTION OF THE EXEMPLARY EMBODIMENTS

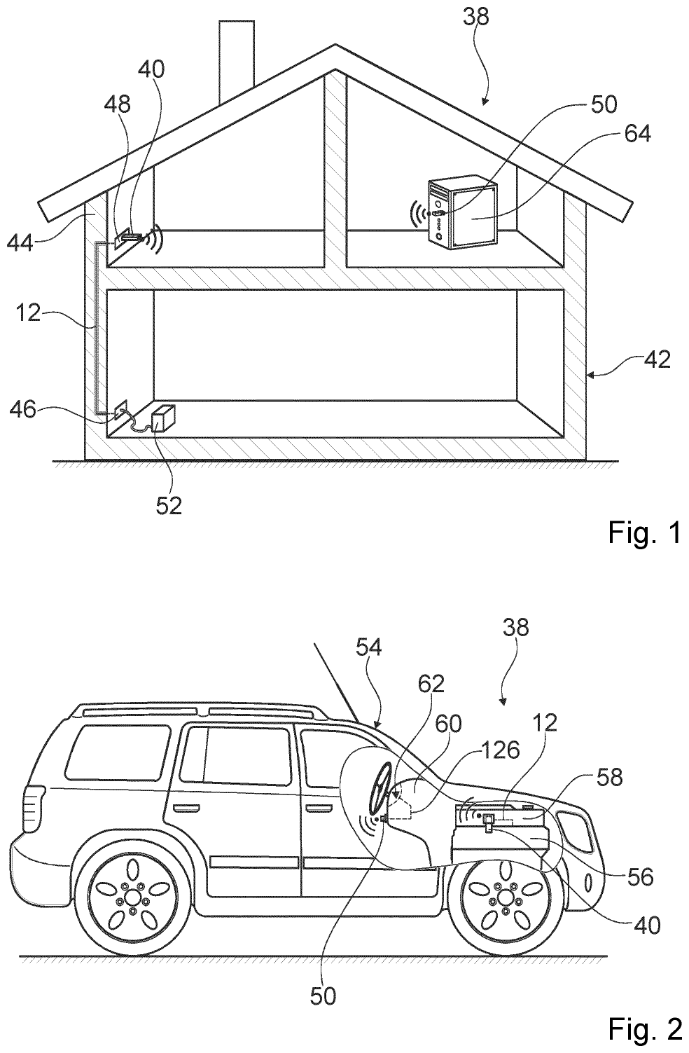

FIGS. 1 and 2 show a transceiver system 38 in two different application examples. The application example of FIG. 1 relates to a building 42. The building 42 includes a data line 12 fixedly installed in a wall 44 of the building 42. The data line 12 is configured to transmit an electrical data signal 16. The electrical data signal 16 is an electrical voltage signal. The electrical data signal 16 is a Recommended Standard 232 (RS-232) signal. The data line 12 is formed as an RS-232 data line. The data line 12 comprises two data sockets 46, 48 arranged in different rooms of the building 42. The data sockets 46, 48 are formed as RS-232 data sockets, for example as D-subminiature DE09 data sockets. A system 52 is plugged into a data socket 46 and transmits the electrical data signal 16, in particular an RS-232 signal. The system 52 feeds the data signal 16 into the data line 12. In this example, the system 52 forms a generator of the electrical data signal 16. In this example, the system 52 is formed as a computer server. Data signals, in particular RS-232 data signals and/or UART data signals, can be transmitted via the transceiver system 38 to another system 64, formed by way of example as a computer server, which is located, for example, in a third room of the building 42, without having to modify a cable routing inside or outside the walls 44 of the building for this purpose.

The application example of FIG. 2 relates to a means of transport 54. The means of transport 54 is formed by way of example as a vehicle, in particular an automobile. The means of transport 54 has an engine 56 with an engine control device 58. The engine control device 58 has a data socket 46 implemented as an RS-232 data socket. The data socket 46 of the engine control device 58 forms a data output of the engine control device 58. The means of transport 54 comprises a dashboard 60. The dashboard 60 comprises a display panel and/or instrument panel 62. The dashboard 60 comprises a data socket 48 implemented as an RS-232 data socket. The data socket 48 of the dashboard 60 forms a data input for the display panel and/or instrument panel 62. In this example, data signals can be exchanged between the engine control device 58 and the display and/or instrument panel 62 via the transceiver system 38 without the need to modify a wiring harness of the means of transport 54.

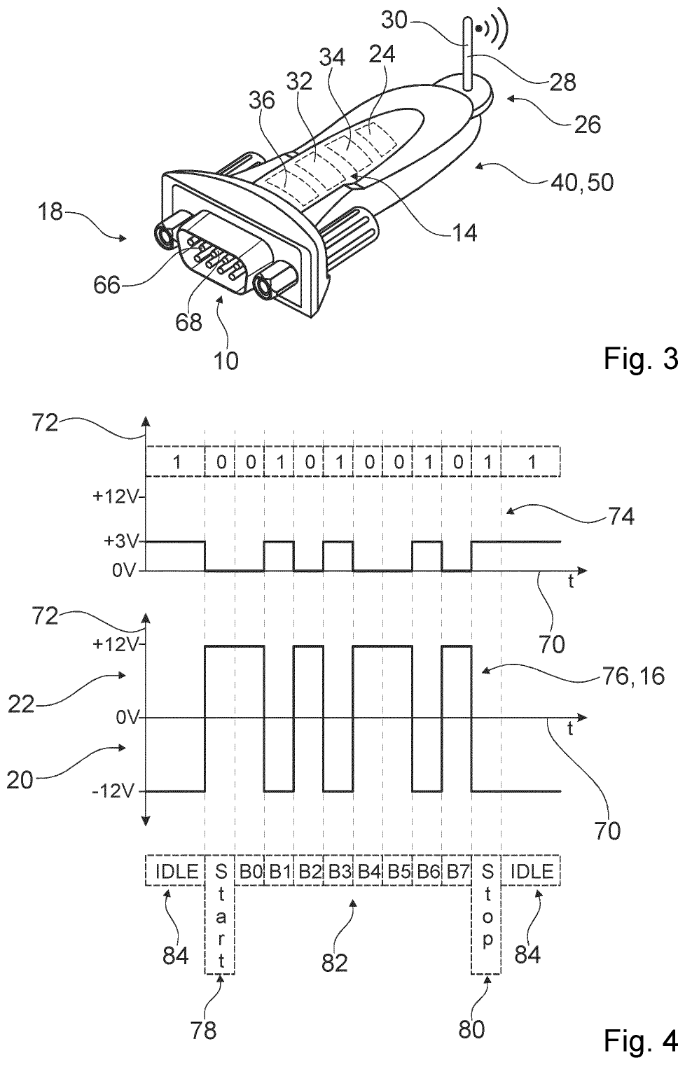

The transceiver system 38 comprises a first electrical connection device 40. In the example of FIG. 1, the first electrical connection device 40 is installed in the data socket 48. The transceiver system 38 in each case comprises a second electrical connection device 50. In the example of FIG. 1, the second electrical connection device 50 is installed in a port of the further system 64. The first electrical connection device 40 has at least one radio module 26 with a transmitter 28 (see also FIG. 3). The second electrical connection device 50 has at least one radio module 26 with a receiver 30 (see also FIG. 3). The radio modules 26 of the electrical connection devices 40, 50 are configured to exchange radio signals. The radio signals communicated between the electrical connection devices 40, 50 may be encrypted or unencrypted. The first electrical connection device 40 and the second electrical connection device 50 are implemented at least substantially identically or complementarily to each other. The power supply to the connecting devices 40, 50 is independent of an external power supply that is different from the data line 12 carrying the electrical data signal 16. In the example of FIG. 1, an electrical data signal 16 output from the system 52 is used to power the first connecting device 40. In the example of FIG. 1, an electrical data signal 16 output from the further system 64 is used to power the second connecting device 50.

FIG. 3 shows a perspective view of the electrical connection device 40, 50 in an exemplary embodiment. The electrical connection device 40, 50 is formed as an electrical plug connector device, in particular as an electrical plug connector. The electrical connection device 40, 50 forms a serial interface 18. The electrical data signal 16 is therefore a Tx signal of the serial interface 18. The electrical connection device 40, 50 forms an RS-232 interface or a UART interface. Therefore, the electrical data signal 16 is a signal of a TxD data line of the RS-232 interface or the UART interface. The electrical connection device 40, 50 comprises a connection element 10. The connection element 10 is configured to be physically connected to the data line 12. The connection element 10 is formed as a male D-subminiature DE-09 connector. Alternative, in particular also female connector forms are conceivable. The connection element 10 has a TxD connection pin 66 for connection to a TxD data line.

The electrical connection device 40, 50 has a plug and play functional principle. The electrical connection device 40, 50 comprises a signal harvesting unit 14, in particular for implementing the plug and play functional principle. The signal harvesting unit 14 is formed as an RS-232 signal harvesting unit. The signal harvesting unit 14 is configured to divert at least a portion 20, 22 of an electric data signal 16 output from the data line 12 in order to obtain electric power. The signal harvesting unit 14 is configured to divert the portion 20, 22 of the electrical data signal 16 output from the data line 12 in order to obtain electrical operating power for signal-based data conversion and/or for radio-based signal transmission of the information content of the electrical data signal 16. The signal harvesting unit 14 is configured to divert the portion 20, 22 of the electrical data signal 16 output from the data line 12 in order to obtain an electrical charging current for energy storage. The signal harvesting unit 14 comprises an electrical circuit which diverts the portion 20, 22 of the electric data signal 16 output from the data line 12 in order to obtain the electrical operating power and/or in order to obtain the charging current. The signal harvesting unit 14 comprises an electrical circuit that passes only a (minimal) portion of the electrical data signal 16 necessary for information transmission.

The electrical connection device 40, 50 comprises a data processing unit 24. The data processing unit 24 is formed as a microcontroller. The data processing unit 24 is configured to convert, in a signal-based manner, the electrical data signal 16 output from the data line 12. The data processing unit 24 is directly supplied with electric power (diverted from the electric data signal 16 by the signal harvesting unit 14) from the signal harvesting unit 14.

The electrical connection device 40, 50 comprises a radio module 26. The radio module 26 comprises the transmitter 28. The transmitter 28 of the radio module 26 is configured to wirelessly emit the information contained in the electrical data signal 16. The data processing unit 24 is configured to convert, in a signal-based manner, the electrical data signal 16 output from the data line 12 into a radio data signal. The transmitter 28 of the radio module 26 is configured to wirelessly emit the data signal converted in a signal-based manner into radio data signals by the data processing unit 24. The transmitter 28 is embodied as a Bluetooth low-energy antenna. The radio module 26 comprises the receiver 30. The receiver 30 is configured to receive radio data signals, preferably the radio data signals of the transmitter 28 of a further electrical connection device 40, 50 paired with the electrical connection device 40, 50. The data processing unit 24 is configured to convert the radio data signals received by the receiver 30 into an electrical data signal 16, in particular into an RS232 data signal, which can be fed into an electrical (Tx) data line 12. The connection element 10 has a TxD connection pin 68, which is configured for an output of the electrical data signal 16 received by the receiver 30 and then processed accordingly. The electrical connection device 40, 50 comprises a level converter 32. The level converter 32 is configured to increase the electrical data signal 16 received by the receiver 30 and converted by the data processing unit 24 to an RS-232 voltage level. The radio module 26, in particular the transmitter 28 and/or the receiver 30, is directly supplied with electrical energy (diverted from the electrical data signal 16 by the signal harvesting unit 14) from the signal harvesting unit 14.

The signal harvesting unit 14 has a current and/or voltage converter 34. The current and/or voltage converter 34 is formed as a DC-DC converter. The current and/or voltage converter 34 is powered by electrical energy that is diverted from the electrical data signal 16 by the signal harvesting unit 14. The current and/or voltage converter 34 is configured to directly supply electrical energy to one or more functional components of the electrical connection device 40, 50, for example the radio module 26, the data processing unit 24, or the level converter 32. The electrical connection device 40, 50 comprises an energy storage device 36. The energy storage device 36 is configured to store at least a portion of the electrical energy generated by the signal harvesting unit 14. The energy storage device 36 is formed as an accumulator. The current and/or voltage converter 34 is configured to supply the energy storage device 36 with a charging current. Via the energy storage device 36, the radio module 26, in particular the transmitter 28 and/or the receiver 30, the data processing unit 24 and/or the level converter 32, can optionally be supplied indirectly by the signal harvesting unit 14 with electrical energy (diverted from the electrical data signal 16 by the signal harvesting unit 14).

In FIG. 4, a serial UART data signal (74, top) and a serial RS-232 data signal (76, bottom) are shown in voltage-time graphs as examples. A time is plotted on abscissas 70 of each of the voltage-time graphs. An electrical voltage is plotted on ordinates 72 of each of the voltage-time graphs. The electrical data signal 16 shown in FIG. 4 forms a binary signal of the Latin capital letter “J”. Read from right to left, the binary signal of the Latin capital letter “J” is 01001010. The binary signal includes a start signal 78 (start bit) and a stop signal 80 (stop bit). Between the start signal 78 and the stop signal 80, payload 82 is transmitted in the form of (eight) data bits (B0 to B7). Before the start signal 78 and after the stop signal 80, the data transmission can be in an idle state 84.

The serial RS-232 data signal 76 represents a typical electrical data signal 16 transmitted through an RS-232 data line. The serial RS-232 data signal 76 has a voltage level that converts between +12V and −12V. A positive voltage level means here a binary “0” (space). A negative voltage level means here a binary “1” (mark). The voltage level shown in the lower voltage-time graph of FIG. 4 is output when the Latin capital letter “J” is transmitted to the TxD connection pin 66 of the electrical connection device 40, 50. The voltage level shown in the lower voltage-time graph of FIG. 4 is output when the Latin capital letter “J” is transmitted to the TxD connection pin 68 of the electrical connection device 40, 50. In the idle state 84, the voltage level of the serial RS-232 data signal 76 is constant at −12 V.

The UART data signal 74 represents a TTL-compatible electrical data signal 16 that is compatible with, for example, the data processing unit 24, particularly the microcontroller. The serial UART data signal 74 has a voltage level that converts between 0 V and +3 V. The serial UART data signal 74 is inverted relative to the RS-232 data signal. A voltage level of zero means here a binary “0” (space). A positive voltage level (+3 V) means here a binary “1” (mark). The voltage level shown in the upper voltage-time graph of FIG. 4 is output to the data processing unit 24 of the electrical connection device 40, 50 when the Latin capital letter “J” is transmitted. The voltage level shown in the upper voltage-time graph of FIG. 4 is output to the level converter 32 for increase when the Latin capital letter “J” is transmitted. In the idle state 84, the voltage level of the serial UART data signal 74 is constant at +3 V.

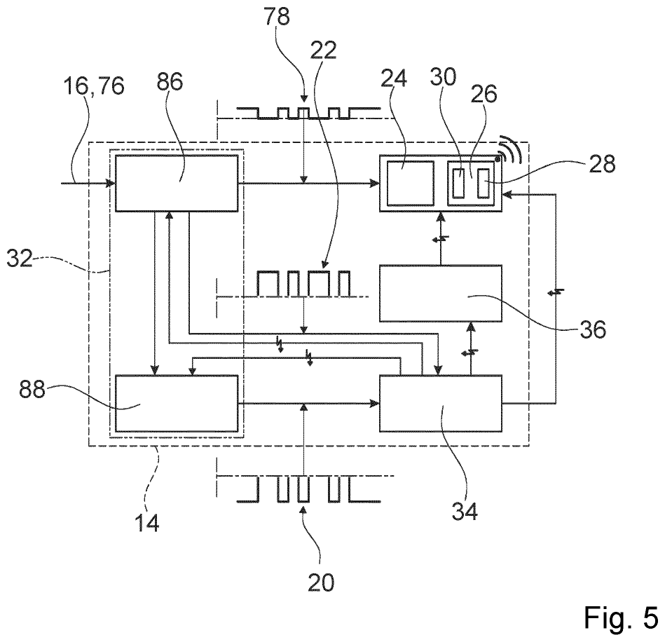

FIG. 5 shows a schematic diagram of an RS-232 data signal 76 entering the electrical connection device 40, 50. By means of a first electronic component 86 of the electrical connection device 40, 50, in particular of the signal harvesting unit 14, for example by means of a positive voltage clamp, by means of the level converter 32, by means of an electrical clipper, by means of an electrical damper or by means of an electrical valve, the portion 22 of the voltage of the RS-232 data signal 76 that carries a positive sign is adjusted and/or limited to a reduced voltage level, for example a transistor-transistor logic (TTL) compatible voltage level. In addition, it is conceivable that the signal harvesting unit 14 is configured to divert the excess portion of the voltage of the electrical voltage signal, that carries a positive sign and that remains after the limiting to the reduced voltage level, in order to obtain electrical energy. The diverted electrical data signal 16, which is adjusted and/or limited to the reduced voltage level, is then inverted, for example by the level converter 32, and thus converted to the UART data signal 74. The UART data signal 74 is output directly to the data processing unit 24, in particular to the microcontroller. The data processing unit 24, in particular the microcontroller, converts the UART data signal 74 into a radio data signal, which in turn is emitted by the transmitter 28 of the radio module 26.

By means of a second electronic component 88 of the electrical connection device 40, 50, in particular of the signal harvesting unit 14, for example by means of a negative voltage clamp, by means of the level converter 32, by means of the electrical clipper, by means of the electrical clamper or by means of an electrical valve, the portion 20 of the voltage of the electrical voltage signal that carries a negative sign is diverted in order to obtain the electrical energy. In addition, it is conceivable that the signal harvesting unit 14 is configured to divert all of the RS-232 data signal 76 output from the data line 12 in the idle state 84 of the RS-232 data signal 76 in order to obtain electrical energy. The electrical voltage signal diverted in order to obtain electrical energy is transmitted to a current and/or voltage converter 34, in particular a DC-DC converter, which thereby provides a charging current for the energy storage device 36 and/or which thereby provides a direct power supply to the data processing unit 24 and/or the radio module 26 and/or the electronic components 86, 88.

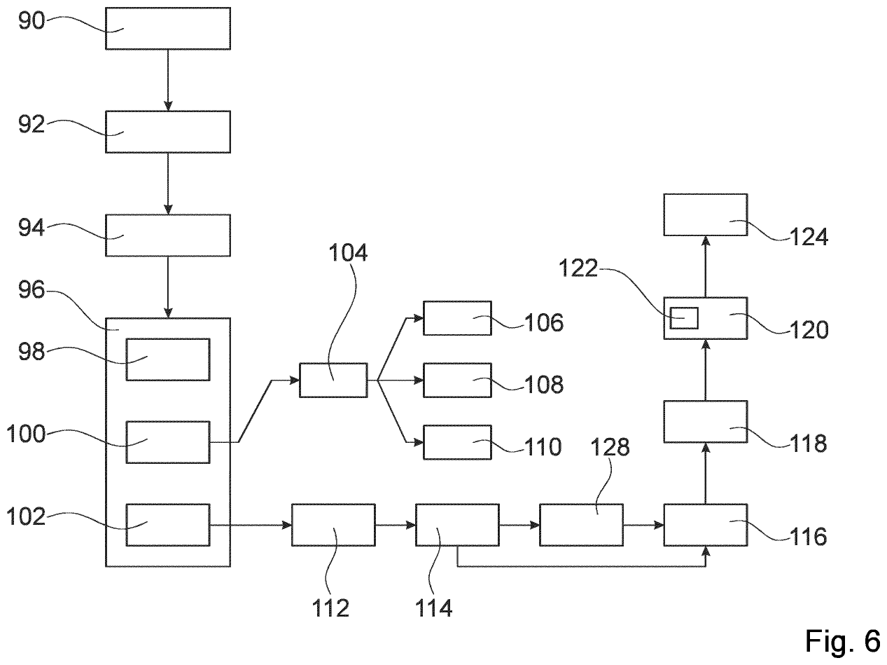

FIG. 6 shows a flowchart of a method for operating the electrical connection device 40, 50. In at least one method step 90, the data line 12 is provided. In at least one further method step 92, the system 52 emitting the electrical data signal 16 is connected to the data socket 46 of the data line 12. In at least one further method step 94, the electrical connection device 40 is connected to the further data socket 48 forming a second end of the data line 12 by plugging in the connection element 10. In the further method step 94, the electrical connection device 40 is ready for use immediately without requiring any adjustments to the system 52 due to the plug-and-play functionality.

In at least one further method step 96, a portion of the electrical data signal 16 emitted by the data line 12 is diverted by means of the signal harvesting unit 14 in order to obtain electrical operating energy for the signal-based data conversion and/or for the radio-based signal transmission. In at least a sub-step 98 of the method step 96, the portion 20 of the voltage of the electrical voltage signal that carries a negative sign is diverted in order to obtain electrical energy. When the electrical data signal 16 is in an RS-232 idle state 84, in the sub-step 98 of the method step 96, an entire RS-232 idle state signal that carries a negative sign is diverted in order to obtain the electrical energy. In at least one further sub-step 100 of the method step 96, the portion 22 of the voltage of the electrical voltage signal that carries a positive sign and that is to be used for an information transmission is adjusted and/or limited to a reduced or a TTL-compatible voltage level. In the sub-step 100 of the method step 96, the portion 22 of the voltage of the electrical voltage signal that is adjusted and/or limited to the reduced or TTL-compatible voltage level is inverted. In the sub-step 100 of the method step 96, the portion 22 of the voltage of the electrical voltage signal that is adjusted and/or limited to the reduced or the TTL-compatible voltage level is converted into the UART data signal 74. In at least one further sub-step 102 of the method step 96, the excess portion of the positive voltage portion 22 of the electrical voltage signal, remaining after the adjustment and/or limitation to the reduced or the TTL-compatible voltage level, is diverted in order to obtain electrical energy.

In at least one further method step 104, the portion of the electrical data signal 16 diverted in order to obtain electrical energy is redirected to the current and/or voltage converter 34. In at least one further method step 106, the energy storage device 36 is charged by the electrical energy obtained by means of the signal harvesting unit 14, in particular by means of the current and/or voltage converter 34. In at least one further method step 108, the data processing unit 24 is operated by the electrical energy obtained by means of the signal harvesting unit 14, in particular by means of the current and/or voltage converter 34. In the method step 108, moreover, the level converter 32 can be operated by the electrical energy obtained by means of the signal harvesting unit 14, in particular by means of the current and/or voltage converter 34. In at least one further method step 110, the radio module 26 is operated by the electrical energy obtained by means of the signal harvesting unit 14, in particular via the current and/or voltage converter 34. In at least one further method step 112, the UART data signal 74 is forwarded directly to the data processing unit 24, in particular to the microcontroller. In at least one further method step 114, the UART data signal 74 is converted into a radio data signal by the data processing unit 24, in particular by the microcontroller. In at least one further optional method step 128, the radio data signal is encrypted. In at least one further method step 116, the radio data signal is emitted by the transmitter 28 of the radio module 26.

In at least one further method step 118, the radio data signal is received by the receiver 30 of a further electrical connection device 50 and, if necessary, decrypted. In at least one further method step 120, the radio data signal is converted into the RS-232 data signal 76 by the data processing unit 24 of the further electrical connection device 50. In at least a sub-step 122 of the method step 120, the RS-232 data signal 76 is increased to a normal RS-232 voltage level by the level converter 32. In at least one further method step 124, the RS-232 data signal 76 is output from the further electrical connection device 50 via its TxD connection pin 68 to the further system 64 or to a further data line 126 (cf. FIG. 2).

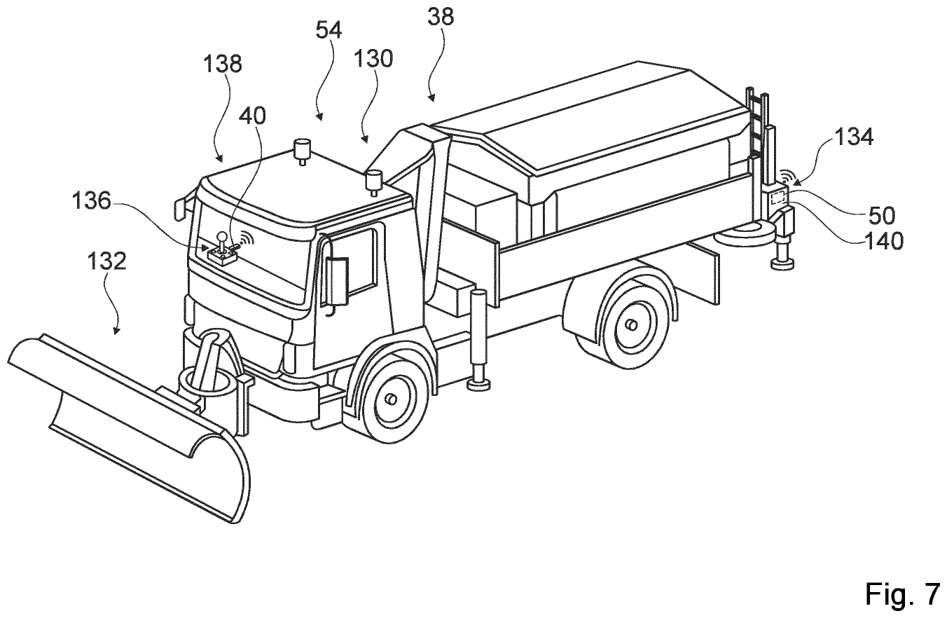

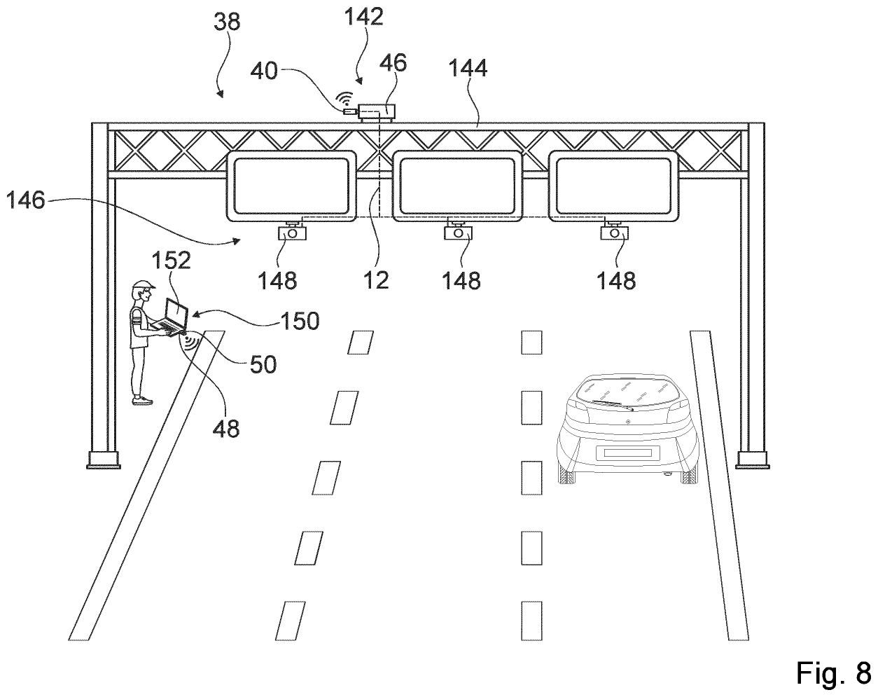

FIGS. 7 and 8 show two further application examples of the transceiver system 38. The application example of FIG. 7 relates to a means of transport 54 formed as a commercial vehicle 130. In the exemplary case shown, the commercial vehicle 130 comprises a snow shovel 132 and a salt spreader 134. The salt spreader 134, for example, a salt spread rate setting of the salt spreader 134, is controllable from a driver's cab 138 of the commercial vehicle 130 by means of an operating lever 136 of the commercial vehicle 130. The operating lever 136 comprises a data socket (not shown) formed as an RS-232 data socket. The data socket of the operating lever 136 forms a data output of the operating lever 136. The salt spreader 134, in particular a control unit of the salt spreader 134, comprises a data socket formed as an RS-232 data socket (not shown). The data socket of the salt spreader 134 is arranged within a housing 140 of the salt spreader 134 so as to be protected from external influences such as salt, moisture or dirt. The data socket of the salt spreader 134 forms a data input to a controller of the salt spreader 134. In this example, data signals generated by an operator of the commercial vehicle 130 from the driver's cab 138 of the commercial vehicle 130 by an operation of the operating lever 136 can be transmitted to the salt spreader 134, in particular to the control unit of the salt spreader 134, via the transceiver system 38 without the need for complex cable routing within the commercial vehicle 130 for this purpose.

The application example of FIG. 8 relates to a traffic monitoring device 146 integrated into a traffic infrastructure 142. The traffic infrastructure 142 is formed by way of example as a road sign structure 144, on which sensors 148 of the traffic monitoring device 146 are mounted. For example, the sensors 148 of the traffic monitoring device 146 can be formed of radar sensors which are configured for traffic counting. The traffic infrastructure 142 includes a data socket 46 embodied as an RS-232 data socket. The traffic monitoring device 146 is connected to the data socket 46 of the traffic infrastructure 142 via a data line 12. The data socket 46 forms a data output of the traffic monitoring device 146. The traffic monitoring device 146 includes a readout device 150. The readout device 150 must be signal-connected to the sensors 148 in order to read out data from the sensors 148. The readout device 150 comprises a data socket 48 formed as an RS-232 data socket. The data socket 48 of the readout device 150 forms a data input for a display 152 of the readout device 150. Electrical connection devices 40, 50 corresponding to each other and forming the transceiver system 38 are plugged into the data sockets 46, 48. In this example, data signals can be exchanged between the sensors 148 and the readout device 150 via the transceiver system 38 without the need to climb the road sign structure 144 and directly connect the readout device 150 to the data socket 46 of the traffic monitoring device 146 integrated in the road sign structure 144.

### REFERENCE SIGNS

10 connection element

12 data line

14 signal harvesting unit

16 electrical data signal

18 serial interface

20 portion

22 portion

24 data processing unit

26 radio module

28 transmitter

30 receiver

32 level converter

34 current and/or voltage converter

36 energy storage device

38 transceiver system

40 electrical connection device

42 building

44 wall

46 data socket

48 data socket

50 electrical connection device

52 system

54 means of transport

56 engine

58 engine control device

60 dashboard

62 display and/or instrument panel

64 system

66 TxD connection pin

68 RxD connection pin

70 abscissa

72 ordinate

74 UART data signal

76 RS-232 data signal

78 start signal

80 stop signal

82 payload

84 idle state

86 first electronic component

88 second electronic component

90 method step

92 method step

94 method step

96 method step

98 sub-step

100 sub-step

102 sub-step

104 method step

106 method step

108 method step

110 method step

112 method step

114 method step

116 method step

118 method step

120 method step

122 sub-step

124 method step

126 data line

128 method step

130 commercial vehicle

132 snow shovel

134 salt spreader

136 operating lever

138 driver's cab

140 housing

142 traffic infrastructure

144 road sign structure

146 traffic monitoring device

148 sensor

150 readout device

152 display

1. An electrical connection device, in particular an electrical plug connector device, having at least one connection element which is configured for a physical connection to a data line, comprising a signal harvesting unit, in particular an RS-232 signal harvesting unit, which is configured to divert at least a portion of an electrical data signal emitted by the data line in order to obtain electrical energy, in particular at least to obtain electrical operating energy for signal-based data conversion and/or for radio-based signal transmission.

2. The electrical connection device as claimed in claim 1, wherein the electrical data signal is an electrical voltage signal.

3. The electrical connection device as claimed in claim 2, wherein the electrical data signal is a Recommended Standard 232 (RS-232) signal or a Universal Asynchronous Receiver Transmitter (UART) signal of a serial interface.

4. The electrical connection device as claimed in claim 3, wherein the electrical data signal is at least a Tx signal of the serial interface.

5. The electrical connection device as claimed in claim 1, comprising a plug and play functional principle.

6. The electrical connection device as claimed in claim 2, wherein the signal harvesting unit is configured to divert the portion of the voltage of the electrical voltage signal that carries a negative sign at least partially, preferably completely, in order to obtain the electrical energy.

7. The electrical connection device as claimed in claim 2, wherein the signal harvesting unit is at least configured to adjust the portion of the voltage of the electrical voltage signal that carries a positive sign to a reduced voltage level.

8. The electrical connection device as claimed in claim 2, wherein the signal harvesting unit is at least configured to at least partially divert the portion of the voltage of the electrical voltage signal that carries a positive sign in order to obtain electrical energy.

9. The electrical connection device as claimed in claim 8, wherein the signal harvesting unit is at least configured to completely divert at least a portion, in particular a temporal part, of an electrical voltage signal that carries a positive sign and forms a bit, in order to obtain electrical energy.

10. The electrical connection device as claimed in claim 1, comprising a data processing unit for signal-based conversion of the electrical data signal emitted by the data line.

11. The electrical connection device as claimed in claim 10, wherein the data processing unit is supplied with electrical energy directly or indirectly by the signal harvesting unit.

12. The electrical connection device as claimed in claim 1, comprising a radio module having a transmitter which is at least configured to wirelessly emit the information contained in the electrical data signal.

13. The electrical connection device as claimed in claim 1, comprising a radio module having a receiver which is at least configured to receive radio data signals.

14. The electrical connection device as claimed in claim 10, wherein the data processing unit is configured to convert the radio data signals received by the receiver into an electrical data signal, in particular into an RS-232 data signal, which can be fed into an electrical (Tx or Rx) data line.

15. The electrical connection device as claimed in claim 12, wherein the radio module is supplied with electrical energy directly or indirectly by the signal harvesting unit.

16. The electrical connection device as claimed in claim 1, comprising an energy storage device for storing at least a portion of the electrical energy obtained by the signal harvesting unit.

17. The electrical connection device as claimed in claim 16, wherein the signal harvesting unit comprises a current and/or voltage converter, in particular a DC-DC converter, which is fed by electrical energy diverted by the signal harvesting unit and which is configured to supply the energy storage device with a charging current.

18. The electrical connection device as claimed in claim 1, wherein the signal harvesting unit comprises a current and/or voltage converter, in particular a DC-DC converter, which is fed by electrical energy diverted by the signal harvesting unit and which is at least configured to supply a functional component of the electrical connection device with electrical energy.

19. The electrical connection device as claimed in claim 1, wherein the signal harvesting unit is configured to divert, at least time-segment-wise, in particular at least in an idle state of the electrical data signal, the entire electrical data signal emitted by the data line in order to obtain electrical energy.

20. A transceiver system having at least one first electrical connection device and at least one second electrical connection device both being implemented as claimed in claim 1, wherein the first electrical connection device comprises at least one radio module having a transmitter, and wherein the second electrical connection device comprises at least one radio module having a receiver.

21. The transceiver system as claimed in claim 20, wherein a power supply of the connecting devices is independent of an external power supply that is different from a data line carrying an electrical data signal.

22. A method for operating an electrical connection device, having at least one connection element which is physically connected to a data line, wherein in order to obtain electrical energy, in particular at least to obtain electrical operating energy for a signal-based data conversion and/or for a radio-based signal transmission, at least a portion of an electrical data signal emitted by the data line is diverted by means of a signal harvesting unit, in particular an RS-232 signal harvesting unit.
